(19) United States
(12) Patent Application Publication
(10) Pub. No.: US 2013/0053157 A1
(43) Pub. Date: Feb. 28, 2013

(54) ROTATING SHAFT STRUCTURE

(71) Applicants: AN SZU HSU, NEW TAIPEI CITY (TW); CHIEN NAN TSAI, NEW TAIPEI CITY (TW)

(72) Inventors: AN SZU HSU, NEW TAIPEI CITY (TW); CHIEN NAN TSAI, NEW TAIPEI CITY (TW)

(73) Assignee: FIRST DOME CORPORATION, NEW TAIPEI CITY (TW)

(21) Appl. No.: 13/222,122

(22) Filed: Aug. 31, 2011

(51) Int. Cl. F16C 3/02

(52) U.S. Cl. 464/179

(57) ABSTRACT

An improved rotating shaft structure includes an assembly of a rotating shaft and a bridge connector. The bridge connector includes a first bridge connecting element and a second bridge connecting element, wherein the first and second bridge connecting elements respectively include a pivotal portion and a bolt hole, and the pivotal portions of the first and second bridge connecting elements define a space or slotted chamber to pivot to the rotating shaft. A fastener is assembled to the bolt holes of the first and second bridge connecting elements of the bridge connector to allow the rotating shaft of being rotated or stopped to be positioned in the space or slotted chamber defined by the pivotal portions of the first and second bridge connecting elements of the bridge connector. Conditions such as inferior rotation and positioning effects of the conventional structure applied to the high-torque rotating shaft device can be improved.

### BACKGROUND OF THE INVENTION

1. Field of the Invention

The present invention relates to an improved rotating shaft structure for an electronic device, and in particular relates to an assembly of a rotating shaft and a bridge connector capable of generating rotational and positioning functions in the operating and positioning processes.

2. Description of the Related Art

Electronic devices, such as mobile phones, notebook computers, personal digital assistants (PDAs), digital cameras and E-books, are conventionally provided with pivotal shafts or rotating shafts, capable of being reciprocally rotated by an external force to open or close a cover, a display monitor or a viewing window thereof. These pivotal shafts or rotating shafts are usually assembled with components formed with holes thereon, such as washers, friction plates and elastic elements, and fasteners are fixed at two ends of the rotating shaft to prevent the washers, friction plates and elastic elements from axial displacement, so that a rotating shaft structure provided with axial packing is formed. In conventional arts, a pivotal shaft or rotating shafts capable of being immediately positioned after rotation is disclosed.

One topic related to operation, movement and structural design of the case above is that embedded structures such as positioning flanges, concaves or concave-convex positioning portions are disposed on washers, friction plates or the related components, so that a positioning function is formed when the rotating flange is located at the concave in the rotating operation of the rotating shaft. As known by those who skilled in the arts, when these positioning flanges, concaves or concave-convex positioning portions applied in large-torque or large electronic products are suffered for a long time operation, the imperfect conditions such as regular abrasions and unsuitable positioning effects are occurred thereon.

Another topic related to the structural design of the pivotal shaft or rotating shaft is that a combination of washers and friction plates applied in the prior arts is incorporated with elastic rings or springs to store or release energy, to attain the rotating and positioning functions of the rotating shaft or pivotal shaft. However, the structural design and assembly installations of this conventional art are more complicated and cannot meet the actual requirements.

These representative reference data above disclose the conditions of operative and structural designs related to the rotating shafts or the related components. Actually, the rotating shafts or the related components and the applications applied in the prior arts still can be redesigned to reduce the complications of the structures and assembly installations and to increase the operation stability and serviceability of the high-torque or large-sized electronic products by altering the type of use, but a further improvement is not physically taught or disclosed in these reference data.

### BRIEF SUMMARY OF THE INVENTION

In view of this, the main purpose of the present invention is to provide an improved rotating shaft structure with rotational and positioning functions. The improved rotating shaft structure comprises an assembly of a rotating shaft and a bridge connector. The bridge connector comprises a type of symmetry formed by a first bridge connecting element and a second bridge connecting element, wherein the first and second bridge connecting elements respectively comprise a pivotal portion and a bolt hole, and the pivotal portions of the first and second bridge connecting elements commonly define a space or slotted chamber to pivot to the rotating shaft. At least one fastener is assembled to the bolt holes of the first and second bridge connecting elements of the bridge connector to allow the rotating shaft of being rotated or stopped to be positioned in the space or slotted chamber defined by the pivotal portions of the first and second bridge connecting elements of the bridge connector. Conditions such as inferior rotation and positioning effects of the conventional structure applied to the high-torque rotating shaft device can be improved.

According to the improved rotating shaft structure of the present invention, the first and second bridge connecting elements of the bridge connector are provided with flange portions disposed on a horizontal reference axis and connected to two sides of the pivotal portion, and the bolt hole is disposed on the flange portion. When the first and second bridge connecting elements of the bridge connector are correspondingly arranged, the fasteners, respectively passed through and assembled to the bolt holes of the first and second bridge connecting elements of the bridge connector, can be utilized to adjust the clearance in between the first and second bridge connecting elements of the bridge connector.

According to the improved rotating shaft structure of the present invention, the pivotal portions of the first and second bridge connecting elements of the bridge connector, formed as a type of arch or inverted U-shaped section, commonly define the inner space or slotted chamber to assemble to the rotating shaft.

According to the improved rotating shaft structure of the present invention, the fastener is provided with an elastic element. The first and second bridge connecting elements of the bridge connector have an elastic vibration range to absorptively prevent the rotating shafts from being damaged by other external forces or mechanical vibrations.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an outside view showing an assembly of a rotating shaft and a bridge connector of an embodiment of the present invention;

FIG. 2 is a schematic exploded view of the structure in FIG. 1;

FIG. 3 is a schematic sectional view showing the assembled structure of a bridge connector, a fastener and a rotating shaft in FIG. 1;

FIG. 4 is a schematic outside view showing a modified embodiment of the present invention;

FIG. 5 is a schematic exploded view of the structure in FIG. 4;

FIG. 6 is a schematic sectional view showing the assembled structure of a bridge connector, a fastener and a rotating shaft in FIG. 4.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

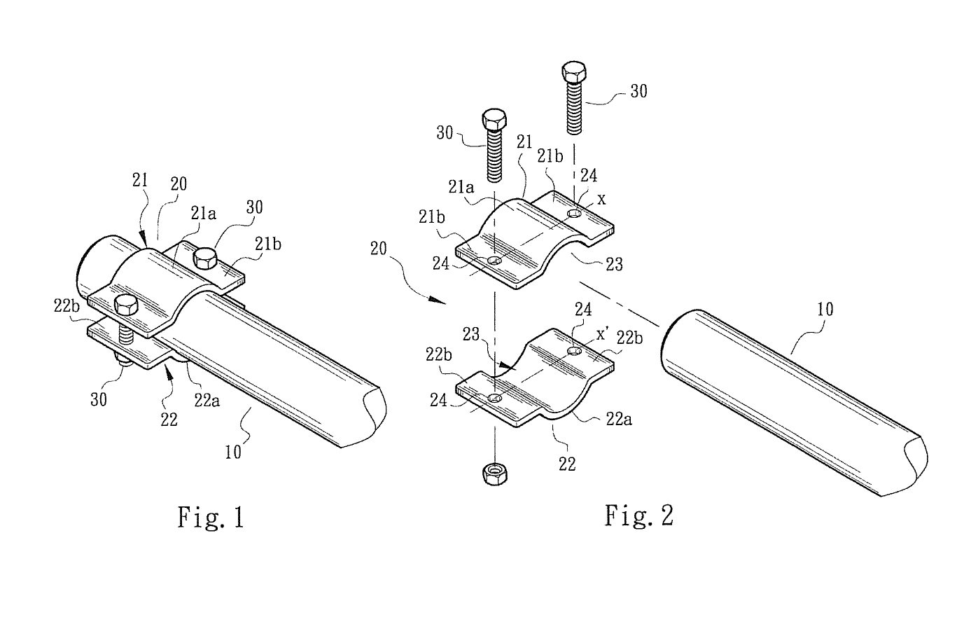

Referring to FIGS. 1, 2 and 3, an improved rotating shaft structure comprises an assembly of a rotating shaft 10 and a bridge connector 20. The rotating shaft 10 is selected of a type of pillar body, capable of being fixed assembled to or attached on an electronic device (not shown in Figs.). In the preferred embodiment, the bridge connector 20 comprises a type of symmetry formed by a first bridge connecting element 21 and a second bridge connecting element 22, wherein the first bridge connecting element 21 comprises a pivotal portion 21a and the second bridge connecting element 22 comprises a pivotal portion 22a, and the pivotal portions 21a and 22a of the first and second bridge connecting elements 21 and 22 commonly define an inner space or a slotted chamber 23 to pivot to the rotating shaft 10.

As shown in these figures, the pivotal portions 21a and 22a of the first and second bridge connecting elements 21 and 22 of the bridge connector 20 are formed as a type of arch or inverted U-shaped section. The first bridge connecting element 21 further comprises two flange portions 21b disposed on a horizontal reference axis x and connected to two sides of the pivotal portion 21a and two bolt holes 24 respectively disposed on the two flange portions 21b, and the second bridge connecting element 22 further comprises two flange portions 22b disposed on a horizontal reference axis x′ and connected to two sides of the pivotal portion 22a and two bolt holes 24 respectively disposed on the two flange portions 22b. Two fasteners 30 are respectively assembled to the bolt holes 24 of the first and second bridge connecting elements 21 and 22 of the bridge connector 20 to allow the rotating shaft 10 of being rotated or stopped to be positioned in the space or slotted chamber 23 defined by the pivotal portions 21a and 22a of the first and second bridge connecting elements 21 and 22 of the bridge connector 20. In the embodiment, the fastener 30 is selected of a type of bolt.

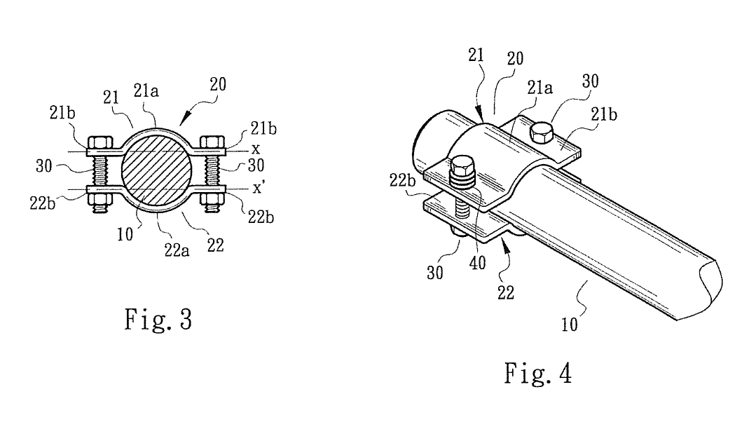

Referring to FIG. 3, when the first and second bridge connecting elements 21 and 22 of the bridge connector 20 are correspondingly arranged, the fasteners 30 respectively passed through and assembled to the bolt holes 24 of the first and second bridge connecting elements 21 and 22 of the bridge connector 20 can be utilized to adjust the clearance and loose-tight degree in between the first and second bridge connecting elements 21 and 22 of the bridge connector 20.

Two design considerations provided in the allocation type of the first and second bridge connecting elements 21 and 22 of the bridge connector 20 and the rotating shaft 10 are required to explain as below.

Firstly, with the allocation mechanism of the first and second bridge connecting elements 21 and 22 of the bridge connector 20 and the fasteners 30 capable of being adjusted in accordance with the torque or acting force required by the electronic products, the first and second bridge connecting elements 21 and 22 of the bridge connector 20 and the rotating shaft 10 are particularly intended for a high-torque required or large-sized electronic products. That is, with the structural type of the first and second bridge connecting elements 21 and 22 of the bridge connector 20, the fasteners 30 can have an allowance sufficient to adjust the loose-tight degree of the first and second bridge connecting elements 21 and 22 of the bridge connector 20 for satisfying the actual requirement of the rotating shaft 10. With the adjustment of the loose-tight degree in between the first and second bridge connecting elements 21 and 22 of the bridge connector 20 and the rotating shaft 10, the rotating shaft 10 can be immediately positioned after the rotating shaft 10 is rotated, such that the conditions such as inferior rotation and positioning effects of the conventional structure applied to the high-torque rotating shaft device can be improved.

Secondly, the allocation mechanism in between the first and second bridge connecting elements 21 and 22 of the bridge connector 20 and the fasteners 30, particularly illustrated in FIG. 3, can allow a clearance to be formed between the first and second bridge connecting elements 21 and 22 of the bridge connector 20 to assemble with the rotating shafts 10 of different sizes or specifications. That is, the rotating shafts 10 of different diameters or sizes are allowable to be assembled in the inner space or slotted chamber 23 defined by the pivotal portions 21a and 22a of the first and second bridge connecting elements 21 and 22 of the bridge connector 20, and the loose-tight degree and the rotational/positioning functions of the assembly of the first and second bridge connecting elements 21 and 22 of the bridge connector 20 and the rotating shaft 10 can be adjusted by the fasteners 30.

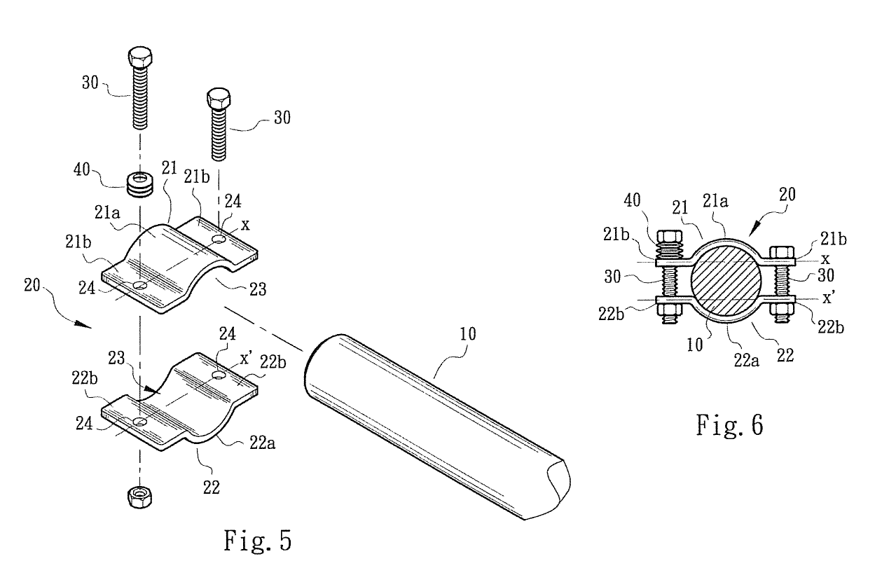

Referring to FIGS. 4, 5 and 6, a modified embodiment of the present invention is illustrated, comprising the rotating shaft 10, the bridge connector 20, and at least one fastener 30 provided with an elastic element 40, wherein the elastic element 40 is pressed on the bolt hole 24 of the flange portion 21b of the first bridge connecting element 21. In this embodiment, the elastic element 40 is selected of a type of helical spring. With the fastener 30 provided with the elastic element 40, it is understood that the first and second bridge connecting elements 21 and 22 of the bridge connector 20 have an elastic vibration range to absorptively prevent the rotating shafts 10 from being damaged by other external forces or mechanical vibrations.

In comparison with the conventional skills, the improved rotating shaft structure of the present invention provided with the conditions of operative rotation and positioning function is representatively characterized with the considerations and advantages as follows.

Firstly, with the rotating shaft 10 and the structures of the related components (e.g., the space or slotted chamber 23 defined by the pivotal portions 21a and 22a of the first and second bridge connecting elements 21 and 22 of the bridge connector 20, the flange portions 21b and 22b, and the fasteners 30) of the present invention, it is obviously that the structural features of the present invention are much different from those of washers and friction plates applied in the prior arts, and the imperfect conditions such as regular abrasions and unsuitable positioning effects occurred at the embedded structures of the positioning flanges, the concaves or the concave-convex positioning portions applied on the conventional components for a long-term operation can be also improved.

Secondly, with the allocation structure of the rotating shaft 10, the first and second bridge connecting elements 21 and 22 of the bridge connector 20, and the fasteners 30 of the present invention, the design for the overall structure of washers and friction plates and the complicated assembly installations applied in the prior arts can be simplified.

In summary, the present invention provides an effective improved rotating shaft structure with spatial arrangement and advantages superior to the conventional arts. While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An improved rotating shaft structure, comprising:
an assembly of a rotating shaft and a bridge connector comprising a type of symmetry formed by a first bridge connecting element and a second bridge connecting element, each of the first and second bridge connecting elements having a transversely symmetrical configuration relative to an axis of the rotating shaft defined by a pivotal portion and a pair of opposing flange portions extending transversely therefrom, each flange portion having a bolt hole, the pivotal portions of the first and second bridge connecting elements correspondingly shaped to define a space or slotted chamber to slidably capture the rotating shaft therebetween; and
at least one fastener assembled to each of the bolt holes of the first and second bridge connecting elements of the bridge connector, the first and second bridge connecting elements remaining spaced one from the other by the fastener to allow slidable retention of the rotating shaft in the space or slotted chamber defined by the pivotal portions of the first and second bridge connecting elements of the bridge connector.

2. The improved rotating shaft structure as claimed in claim 1, wherein the pivotal portions of the first and second bridge connecting elements of the bridge connector are formed as a type of arch section.

3. The improved rotating shaft structure as claimed in claim 1, wherein the flange portions of the first and second bridge connecting elements of the bridge connector are disposed on a transverse reference axis, the flange portions extend from opposing sides of the pivotal portions and the bolt holes are disposed on the flange portions.

4. The improved rotating shaft structure as claimed in claim 2, wherein the flange portions of the first and second bridge connecting elements of the bridge connector are disposed on a transverse reference axis, the flange portions extend from opposing sides of the pivotal portions and the bolt holes are disposed on the flange portions.

5. The improved rotating shaft structure as claimed in claim 1, wherein the fasteners are provided with an elastic element.

6. The improved rotating shaft structure as claimed in claim 5, wherein the elastic element is pressed on the bolt holes of the first bridge connecting element.

7. The improved rotating shaft structure as claimed in claim 5, wherein the elastic element is selected of a type of helical spring.

8. The improved rotating shaft structure as claimed in claim 6, wherein the elastic element is selected of a type of helical spring.

9. The improved rotating shaft structure as claimed in claim 1, wherein the rotating shaft is selected of a type of pillar body.

10. The improved rotating shaft structure as claimed in claim 1, wherein the fasteners are selected of a type of bolt.

11. The improved rotating shaft structure as claimed in claim 1, wherein the rotating shaft is attached on an electronic device.

12. An improved rotating shaft structure, comprising:
a bridge connector comprising a type of symmetry formed by a first bridge connecting element and a second bridge connecting element, each of the first and second bridge connecting elements having a transversely symmetrical configuration relative to an axis of the rotating shaft defined by a pivotal portion and a pair of opposing flange portions extending transversely therefrom, each flange portion having and a bolt hole, the pivotal portions of the first and second bridge connecting elements correspondingly shaped to define a space or slotted chamber; and
at least one fastener assembled to each of the bolt holes of the first and second bridge connecting elements of the bridge connector, the first and second bridge connecting elements remaining spaced from one another by the fastener to allow slidable retention of the rotating shaft, the fasteners including an elastic element pressed onto the bolt holes of the first bridge connecting element.

13. The improved rotating shaft structure as claimed in claim 12, wherein the pivotal portions of the first and second bridge connecting elements of the bridge connector are formed as a type of arch section.

14. The improved rotating shaft structure as claimed in claim 12, wherein the flange portions of the first and second bridge connecting elements of the bridge connector are disposed on a transverse reference axis, the flange portions extend from opposing sides of the pivotal portions, and the bolt holes are disposed on the flange portion.

15. The improved rotating shaft structure as claimed in claim 13, wherein the flange portions of the first and second bridge connecting elements of the bridge connector are disposed on a transverse reference axis, the flange portions extend from opposing sides of the pivotal portions, and the bolt holes are disposed on the flange portion.

16-17. (canceled)

18. The improved rotating shaft structure as claimed in claim 16, wherein the elastic element is selected of a type of helical spring.

19. The improved rotating shaft structure as claimed in claim 12, wherein the fasteners are selected of a type of bolt.
